(19) United States
(12) Patent Application Publication
(10) Pub. No.: US 2012/0325831 A1
(43) Pub. Date: Dec. 27, 2012

(54) PACKAGES FOR CONSUMABLE PRODUCTS AND METHODS OF USING SAME

(75) Inventors: Kimberly Ann Wilmers, Twin Lake, MI (US); Cynthia Lynn Wilcox, Newaygo, MI (US); Stephen Andrew Wurth, St. Louis, MO (US); Bethanie Lynn Skinner, Litchfield, IL (US); Gary William Etheridge, St. Louis, MO (US)

(73) Assignee: NESTEC S.A., Vevey (CH)

(21) Appl. No.: 13/518,472

(22) PCT Filed: Jul. 12, 2010
(86) PCT No.: PCT/US10/41719

§ 371 Date: Aug. 30, 2012

Related U.S. Application Data
(60) Provisional application No. 61/289,549, filed on Dec. 23, 2009.

(51) Int. Cl. B65D 25/00; G09B 19/00; B65D 85/00

(52) U.S. Cl. 220/660; 206/459.5; 434/127

(57) ABSTRACT

Packages (10) for housing consumable products and methods of using same are provided. Methods for teaching children to self-feed are also provided. In a general embodiment, the present disclosure provides a package (10) including a body (12) defining side walls (14,16), a first end wall (18), an inclined second end wall (20) and an elongated interior compartment (24) having a predetermined width for housing consumable products.

### BACKGROUND

The present disclosure relates generally to packaging. More specifically, the present disclosure relates to containers for storing consumable products and methods of using same.

Packaging for consumable products come in a variety of sizes, shapes, materials and designs. These sizes, shapes, materials and designs generally differ, for example, for aesthetic reasons or marketing purposes. Although consumable product packaging may be provided to enhance aesthetic qualities or marketability of packages, the purposes for consumable product packaging are not limited to only these purposes.

Indeed, consumable product packages aimed at providing improved aesthetic qualities or marketability of a package may not ahs as provide optimal functionality. Instead, consumable product packaging having specific shapes and sizes may provide functional advantages to a consumer and/or user of such packages in addition to possible aesthetic and/or marketing advantages.

### SUMMARY

The present disclosure provides packages for housing consumable products and methods of using same. In a general embodiment, a package includes a body defining side walls, a first end wall, an inclined second end wall and an elongated interior compartment for housing consumable products. The elongated interior compartment has a width that is about as wide as an average child's hand.

In an embodiment, the second end wall is inclined with respect to a bottom wall of the body at an angle from about 100° to about 170°. The second end wall may be inclined at an angle of about 135°.

In an embodiment, the first end wall is inclined at an angle with respect to a bottom wall.

In an embodiment, the first end wall is oriented at about 90° with respect to a bottom wall of the body.

In an embodiment, the elongated interior compartment has a length to width ratio from about 6:1 to about 2:1. The length to width ratio may also be about 3:1.

In an embodiment, the body further defines a gripping portion.

In an embodiment, package includes secondary packaging having indicia printed thereon.

In another embodiment, a package is provided. The package includes a body defining side walls, a first end wall, an inclined second end wall and an elongated interior compartment for housing consumable products. The elongated interior compartment has a width that is about as wide as an average eating utensil. The eating utensil may be selected from the group consisting of a spoon, a fork, or combinations thereof.

In an embodiment, the second end wall is inclined with respect to a bottom wall of the body at an angle from about 100° to about 170°. The second end wall may also be inclined at an angle of about 135°.

In an embodiment, the first end wall is inclined at an angle with respect to a bottom wall.

In an embodiment, the first end wall is oriented at about 90° with respect to a bottom wall of the body.

In an embodiment, the elongated interior compartment has a length to width ratio from about 6:1 to about 2:1. The length to width ratio may also be about 3:1.

In an embodiment, the body further defines a gripping portion.

In an embodiment, the package includes secondary packaging having indicia printed thereon.

In an embodiment, the average eating utensil is a spoon.

In yet another embodiment, a package is provided. The package includes a body defining side walls, a bottom wall, a top wall, first end wall oriented at 90° to the bottom wall, a second end wall inclined at an obtuse angle with respect to the bottom wall, and an interior compartment for housing consumable products. The interior compartment gradually tapers in width from the second end wall to the first end wall, and the package is so constructed and arranged to stand upright on at least a portion of first end wall.

In an embodiment, the second end wall is inclined with respect to the bottom wall at an angle from about 100° to about 170°. The second end wall may also be inclined at an angle of about 135°.

In an embodiment, the top wall includes a gripping portion.

In an embodiment, at least a portion of each side wall includes a gripping portion.

In an embodiment, the package includes secondary packaging having indicia printed thereon.

In still yet another embodiment, methods for teaching an individual to self-feed are provided. The methods include providing a package to a child having a body defining side walls, a first end wall, an inclined second end wall and an elongated interior compartment housing consumable products. The second end wall has a width that is about as wide as an average child's hand. The methods further include guiding a child's hand using the elongated interior compartment to teach the child to self-feed.

In another embodiment, methods for teaching a child to self-feed are provided. The methods include providing a package to a child having a body defining side walls, a first end wall, an inclined second end wall and an elongated interior compartment housing consumable products. The second end wall has a width that is about as wide as an average eating utensil. The methods further include providing an eating utensil to the child, and guiding the eating utensil using the elongated interior compartment to teach the child to self-feed.

In yet another embodiment, methods for teaching an individual to self-feed are provided. The methods include providing a package to a child having a body defining side walls, a bottom wall, a top wall, first end wall oriented at 90° to the bottom wall, a second end wall inclined at an obtuse angle with respect to the bottom wall, and an interior compartment housing consumable products. The interior compartment gradually tapers in width from the second end wall to the first end wall. The package is also so constructed and arranged to stand upright on at least a portion of first end wall. The methods further include using the inclined second end wall to scoop the consumable products for self-feeding.

In an embodiment, the consumable products may be scooped using the child's hand.

In still yet another embodiment, methods for marketing consumable products are provided. The methods include providing a package including a body defining side walls, a bottom wall, a top wall, first end wall oriented at 90° to the bottom wall, a second end wall inclined at an obtuse angle with respect to the bottom wall, and an interior compartment housing consumable products. The interior compartment gradually tapers in width from the second end wall to the first end wall, and the package is so constructed and arranged to stand upright on at least a portion of first end wall. The methods further include standing the package on a retail shelf in a substantially upright position such that the package stands on at least a portion of the first end wall.

It is an advantage of the present disclosure to provide an improved consumable product container.

It is also an advantage of the present disclosure to provide consumable product containers that are aesthetically pleasing to children.

It is another advantage of the present disclosure to provide consumable product containers that teach children to self-feed.

It is yet another advantage of the present disclosure to provide consumable product containers that provide improved marketability of the containers.

It is a further advantage of the present disclosure to provide consumable product containers that are easily gripped by caretakers for handling children's foods.

Yet another advantage of the present disclosure is to provide consumable product containers that are easily gripped by children for self-feeding.

Additional features and advantages are described herein, and will be apparent from, the following Detailed Description and the figures.

### BRIEF DESCRIPTION OF THE FIGURES

FIG. 1 illustrates a perspective view of a package in accordance with an embodiment of the present disclosure.

FIG. 2 illustrates a cross-sectional view of a package in accordance with an embodiment of present disclosure and taken along line 2-2 in FIG. 1.

FIG. 3 illustrates a perspective view of a package in accordance with an embodiment of the present disclosure.

### DETAILED DESCRIPTION

The present disclosure provides packages for housing consumable products and methods of using same. Methods for teaching individuals to self-feed are also provided. The individual may be a child or a cognitively impaired individual, for example. In a general embodiment, a package includes a body defining side walls, a first end wall, an inclined second end wall, and an elongated interior compartment for housing consumable products. The second end at may be inclined with respect to a bottom wall of the body at an angle from about 100° to about 170°. The elongated interior compartment may have a certain width. In another general embodiment, a package includes a body defining side walls, a bottom wall, a first end wall oriented at 90° to the bottom wall, a second end wall inclined at an obtuse angle with respect to the bottom wall, and an interior compartment for housing consumable products. The interior compartment gradually tapers in width from the second end wall to the first end wall. The package may be so constructed and arranged to stand substantially upright.

As used herein, an “elongated” interior compartment shape means that a length of an interior compartment of the present packages is greater than a width of the interior compartment. For example, a length to width ratio of an interior compartment of the present disclosure may be from about 6:1 to about 1.5:1. In another embodiment, the length to width ratio of an interior compartment of the present disclosure may be from about 5:1 to about 2:1. In an embodiment, the length to width ratio of an interior compartment of the present disclosure is about 3:1. The skilled artisan will appreciate that, in an embodiment having an elongated interior compartment, the length to width ratio may be any length to width ratio that results in an elongated shape.

Packages of the present disclosure are designed to house consumable products. Consumable products housed in the packages may be any consumable products including, for example, baby foods, snack foods, full meals, side meals, etc. In an embodiment, the packages house foods for children (e.g., infants, toddlers, pre-schoolers, etc.) including, for example, fruits, vegetables, grains, cereals, pastas, etc. The consumable products may be finger foods or may be designed to be consumed using utensils. The teachings of the present disclosure, therefore, are not dependent upon the consumable products being of any particular type so long as the products fit within the packages described herein.

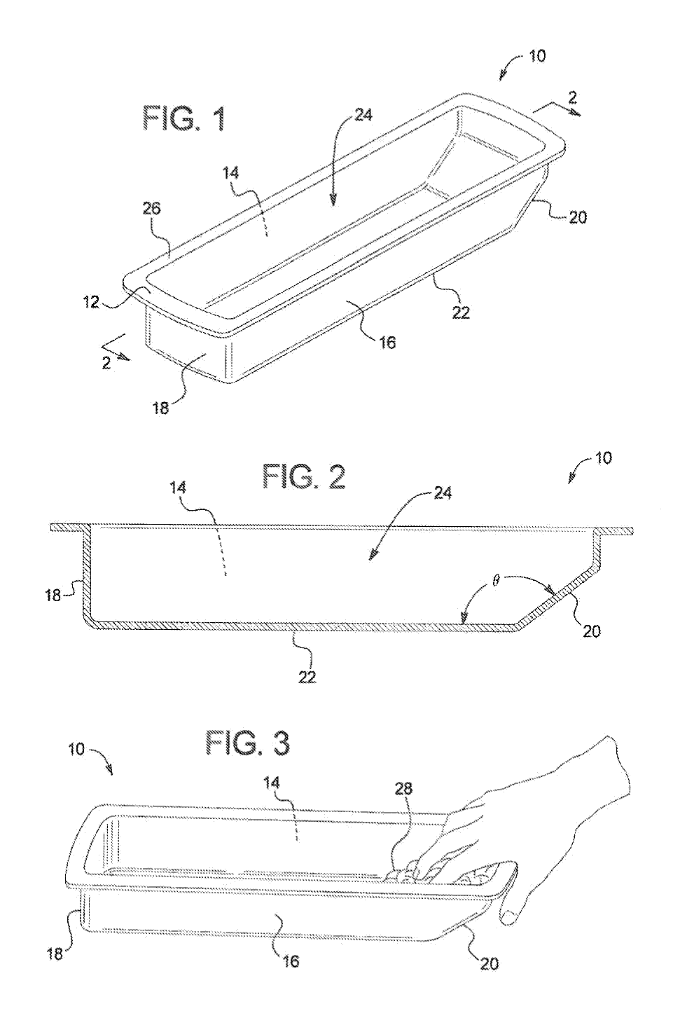

In an embodiment, and as shown in FIGS. 1-3, a package 10 for storing consumable products is provided. Package 10 includes a body 12 that defines side walls 14, 16, end walls 18, 20, a bottom wall 22 and an elongated interior compartment 24. Package 10 is not limited to any particular size so long as consumable products may be contained in elongated interior compartment 24. However, in an embodiment, package 10 houses consumable products designed for children (e.g., infants, toddlers, pre-schoolers), and should be sized accordingly. For example, package 10 should not be so large that a child is unable to easily hold package 10 by his or herself. This will aid in teaching a child to self-feed, as will be discussed further below.

Additionally, package 10 may be sized to be easily held by a caretaker or parent for preparing or administering a meal to a child. For example, package 10 may be about as wide as is comfortable for gripping for an average adult-sized hand. As will be discussed further below, this will allow the caretaker or parent to easily grasp package 10 for scooping food therefrom or for feeding a child.

Body 12 may also have any shape including, for example, polygonal, semi-circular, oblong, or combinations thereof. In an embodiment, body 12 has a polygonal shape selected from the group consisting of rectangular, square, triangular, trapezoidal or combinations thereof. Similarly, elongated interior compartment 24 may have any elongated shape including, for example, polygonal, semi-circular, oblong, or combinations thereof. In an embodiment, and as shown in FIG. 1, body 12 has an elongated rectangular shape and defines an elongated rectangular-shaped interior compartment 24. The skilled artisan will appreciate that neither body 12 nor interior compartment 24 are limited to any particular shape so long as interior compartment 24 is elongated in shape.

Side walls 14, 16 of package 10 may be oriented at a substantially 90° angle to bottom wall 22. In another embodiment, first and second side walls 14, 16 slightly taper from a top wall 26 of package 10 to bottom wall 22.

End walls 18, 20 may also be oriented at a substantially 90° angle to bottom wall 22. In another embodiment, as shown in FIG. 2, first end wall 18 may be oriented at a substantially 90° angle to bottom wall 22, while second end wall 20 may be substantially inclined with respect to bottom wall 22 so as to form a ramp at second end wall 20. In another embodiment, first and second end walls 18, 20 are both substantially inclined so as to form ramps at both ends 18, 20 of package 10. To form a ramp at end wall 18, 20 of package 10, end wall 18, 20 should be oriented at an obtuse angle, θ, with respect to bottom wall 22, as is shown in FIG. 2. In an embodiment, θ ranges from about 100° to about 170°. In another embodiment, θ ranges from about 120° to about 150°. In another embodiment, θ is about 135°.

In embodiments having inclined end walls 18, 20, the inclined portion may be one straight inclined plane extending from bottom wall 22 to top wall 26. Alternatively, inclined end walls 18, 20 may be formed from a series of short inclined planes that form an inclined ramp-like end wall 18, 20, as is shown in FIG. 2. In embodiments formed from a series of short inclined planes, θ may be measured from a first inclined portion adjacent bottom wall 22.

Package 10, which includes at least one inclined end wall 18, 20, provides several benefits to consumers. For example, the inclined shape of second end wall 20 allows a child to self-feed, as is shown in FIG. 3. The child may be able to carry package 10 in one hand, or set package 10 on a supporting surface, and scoop up consumable products 28 contained therein with the other hand. The inclined shape forms a ramp that allows for easier raking of consumable products 28 into the child's hand.

Additionally, in embodiments wherein package 10 is used in conjunction with eating utensils, inclined shape of second end wall 20 may allow for easier pouring or funneling of consumable products from package 10 into another container or onto a plate, for example. The inclined shape of second end wall 20 provides a caretaker or parent of a child the benefits of more easily and efficiently serving food to a child, storing food in a container or cleaning up after a child's meal, among others.

Body 12 further defines an elongated interior compartment 24 having an elongated shape that is designed to house consumable products. Elongated interior compartment 24 may have any shape that is elongated and may be any size known to the skilled artisan. As discussed above, elongated interior compartment 24 may have a length to width ratio of about 6:1 to about 1.5:1. In another embodiment, the length to width ratio may be from about 5:1 to about 2:1. In an embodiment, the length to width ratio is about 3:1. As shown in FIG. 3, the width of elongated interior compartment 24 may be as wide as an average child's hand, which will further aid a child in scooping or raking consumable products 28 into child's hand. In this manner, child's hand will trap consumable products 28 between first and second side walls 14, 16 and bottom wall 22 such that consumable products 28 will readily move up inclined second end wall 20 and into child's hand.

In another embodiment (not illustrated), elongated interior compartment 24 has a width that is about as wide as an average eating utensil such as for example, a fork or a spoon. Such an embodiment will provide several advantages. For example, when package 10 is used by a child in conjunction with an eating utensil such as, for example, a spoon having a bowl portion and a handle, elongated interior compartment 24 may be about as wide as the bowl portion of the spoon to guide the spoon as the child attempts to scoop up consumable products contained in package 10. This is advantageous because elongated interior compartment 24, therefore, aids in teaching a child how to self-feed using eating utensils.

In much the same manner as above with respect to a child's hand, the eating utensil (e.g., a spoon) will trap consumable products between first and second side walls 14, 16 and bottom wall 22 such that consumable products will easily be pushed onto the child's eating utensil. The child may be able to push consumable products toward either first or second end wall 18, 20.

Similarly, elongated interior compartment 24 having a width that is about as wide as an average eating utensil will also provide the advantages that a caretaker or parent may be able to more easily and efficiently serve food to a child, store food in a container or clean up after a child's meal, among others. In this manner, a caretaker or parent may use a utensil (e.g., a spoon) to pour or funnel consumable products out of package 10 and into a storage container onto a child's plate, or into a garbage can for clean up.

Package 10 may also include a lid (not illustrated) or other form of closure such as a removable closure to properly store the consumable products therein. For example, a lid may be made of cardboard, paperboard, lid stock, etc. Alternatively, a removable closure (not shown) such as, for example, a transparent film or a lid stock, may be sealed onto top wall 26 of body 12. Removable closure may be used alone or in conjunction with a lid and may be used to keep the products fresh and to extend the shelf life of the products. Any conventional sealing technique known in the art may be used to seal the removable closure onto top wall 26 of body 12. The techniques may include, but are not limited to, conductive heating, cold sealing, heat sealing, heat activated adhesive, etc.

Package 10 may be made from a molded plastic material such as, for example, polyethylene, polypropylene, or the like, or combinations thereof. Body 12 may be formed using conventional thermoforming or molding processes including, but not limited to, injection molding, injection blow molding and extrusion blow molding. Alternatively, package 10 may be manufactured from non-plastic materials including, but not limited to, cardboard, metal, styrofoam, etc. Further, at least a portion of package 10 can be either transparent or translucent so that a consumer can readily discern what types of products are housed in elongated interior compartment 24 of package 10. Alternatively, at least a portion of package 10 may be opaque. In an embodiment where a lid (not illustrated) is provided, the lid may be translucent while body 12 is opaque.

In addition to having different optical properties, package 10 may also have different colors. Package 10 may have a color selected from the group consisting of white, yellow, orange, red, green, blue, purple, brown, black, etc. For example, in an embodiment, package 10 may be transparent and red in color. Alternatively, package 10 may be opaque and blue in colors. The skilled artisan will appreciate that the optical properties and colors of package 10 are not limiting and that package 10 may have any combination thereof.

Package 10 may include indicia (not illustrated) provided on an exterior and/or interior of body 12 for marketing purposes. The indicia may include, for example, logos, advertisements, branding information, nutritional information, product information, manufacturer information, etc. The indicia may be printed on a pressure sensitive material, printed directly on package 10, printed on a removable closure, etc.

For marketing purposes, package 10 may be provided with secondary packaging (not illustrated) to aid in standing package 10 substantially upright on either end wall 18, 20. Secondary packaging may include a relatively short box that is configured to hold one row of several packages 10 oriented front to back. Secondary packaging may also include a relatively short box that is configured to hold several rows of packages 10 oriented front to back and side to side. The skilled artisan will appreciate that such secondary packaging can be any secondary packaging that provides package 10 with the ability to stand substantially upright on either end wall 18, 20. Such secondary packaging provides the advantage that a consumer is able to view all or a large portion of a front portion of package 10, which provides a much larger billboard marketing area than most consumable product packages currently on the market.

Alternatively, and depending on the shape and size of the overall package 10 including, for example, the shape of ends walls 18, 20, package 10 may also be able to stand substantially upright on a retail shelf without secondary packaging. For example, in an embodiment, end wall 18, 20, in combination with a portion of bottom wall 22, define a plane on which package 10 may stand. In this manner, as long, as package 10 defines a plane (i.e., at least three points of contact) on which package 10 can rest, the shape of body 12 and elongated interior compartment 24 is immaterial. In an embodiment, package 10 may rest in a substantially vertical or upright position or may rest in a position that tilts toward or away from a consumer, depending on the shape of package 10. Regardless of the shape of package 10, if intended to stand substantially upright, package 10 must be able to stand in a stable manner on the plane. In other words, package 10 must be constructed and arranged so that it will not easily fall over when filled with consumable products.

In addition to standing substantially upright, package 10 may also be configured to lay substantially flat on top wall 26 of body 12 or bottom wall 22. Alternatively, package 10 may be provided with a hook portion (not illustrated) a body 12 that is configured to receive a hanger that allows package 10 to be hung from a retail display in a retail store.

In an embodiment, methods for using packages of the present disclosure are also provided. For example, in an embodiment, methods for teaching a child to self-feed are provided. The methods include providing a package to a child having a body defining side walls, a first end wall, an inclined second end wall and an elongated interior compartment housing consumable products. The second end wall has a width that is about as wide as an average child's hand. The methods further include guiding a child's hand using the elongated interior compartment to teach the child to self-feed.

In another embodiment, methods for teaching a child to self-feed are provided. The methods include providing a package to a child having a body defining side walls, a first end wall, an inclined second end wall and an elongated interior compartment housing consumable products. The second end wall has a width that is about as wide as an average eating utensil. The methods further include providing an eating utensil to the child, and guiding the eating utensil using the elongated interior compartment to teach the child to self-feed.

In yet another embodiment, methods for teaching an individual to self-feed are provided. The methods include providing a package to a child having a body defining side walls, a bottom wall, a top wall, first end wall oriented at 90° to the bottom wall, a second end wall inclined at an obtuse angle with respect to the bottom wall, and an interior compartment housing consumable products. The interior compartment gradually tapers in width from the second end wall to the first end wall. The package is also so constructed and arranged to stand upright on at least a portion of first end wall. The methods further include using the inclined second end wall to scoop the consumable products for self-feeding. The consumable products may be scooped using the child's hand.

In still yet another embodiment, methods for marketing consumable products are provided. The methods include providing a package including a body defining side walls, a bottom wall, a top wall, first end wall oriented at 90° to the bottom wall, a second end wall inclined at an obtuse angle with respect to the bottom wall, and an interior compartment housing consumable products. The interior compartment gradually tapers in width from the second end wall to the first end wall, and the package is so constructed and arranged to stand upright on at least a portion of first end wall. The methods further include standing the package on a retail shelf in a substantially upright position such that the package stands on at least a portion of the first end wall.

Providing uniquely designed packaging of the present disclosure advantageously aids in teaching children how to self-feed using an inclined end wall of a package. Additionally, an elongated shape of in interior compartment may serve as a guide means to guide either an eating utensil used by a child, or a hand of a child, for scooping up consumable products contained in the package. Additionally, the packages of the present disclosure also provide improved marketability of consumable product packaging.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A package comprising:
a body defining side walls, a first end wall, an inclined second end wall and an elongated interior compartment for housing consumable products, the elongated interior compartment having a width that is about as wide as an average child's hand.

2. The package of claim 1, wherein the second end wall is inclined with respect to a bottom wall of the body at an angle from about 100° to about 170°.

3. The package of claim 2, wherein the second end wall is inclined with respect to the bottom wall at an angle of about 135°.

4. The package of claim 1, wherein the first end wall is inclined at an angle with respect to a bottom wall.

5. The package of claim 1, wherein the first end wall is oriented at about 90° with respect to a bottom wall of the body.

6. The package of claim 1, wherein the elongated interior compartment comprises a length to width ratio from about 6:1 to about 2:1.

7. The package of claim 6, wherein the elongated interior compartment comprises a length to width ratio of about 3:1.

8. The package of claim 1, the body further defining a gripping portion.

9. The package of claim 1, further comprising secondary packaging having indicia printed thereon.

10. A package comprising:
a body defining side walls, a first end wall, an inclined second end wall and an elongated interior compartment for housing consumable products, the elongated interior compartment having a width that is about as wide as an average eating utensil.

11. The package of claim 10, wherein the second end wall is inclined with respect to a bottom wall of the body at an angle from about 100° to about 170°.

12. The package of claim 11, wherein the second end wall is inclined with respect to the bottom wall at an angle of about 135°.

13. The package of claim 10, wherein the first end wall is inclined at an angle with respect to a bottom wall.

14. The package of claim 10, wherein the first end wall is oriented at about 90° with respect to a bottom wall of the body.

15. The package of claim 10, wherein the elongated interior compartment comprises a length to width ratio from about 6:1 to about 2:1.

16. The package of claim 15, wherein the elongated interior compartment comprises a length to width ratio of about 3:1.

17. The package of claim 10, the body further defining a gripping portion.

18. The package of claim 10, further comprising secondary packaging having indicia printed thereon.

19. The package of claim 10, wherein the average eating utensil is a spoon.

20. A package comprising:
a body defining side walls, a bottom wall, a top wall, first end wall oriented at 90° to the bottom wall, a second end wall inclined at an obtuse angle with respect to the bottom wall, and an interior compartment for housing consumable products, the interior compartment gradually tapering in width from the second end wall to the first end wall, and the package being so constructed and arranged to stand upright on at least a portion of first end wall.

21. The package of claim 20, wherein the second end wall is inclined with respect to the bottom wall at an angle from about 100° to about 170°.

22. The package of claim 20, wherein the second end wall is inclined with respect to the bottom wall at an angle of about 135°.

23. The package of claim 20, the top wall comprising a gripping portion.

24. The package of claim 20, wherein at least a portion of each side wall comprises a gripping portion.

25. The package of claim 20, further comprising secondary packaging having indicia printed thereon.

26. A method for teaching a child to self-feed, the method comprising:
providing a package to a child comprising a body defining side walls, a first end wall, an inclined second end wall and an elongated interior compartment housing consumable products, the second end wall having a width that is about as wide as an average child's hand; and
guiding a child's hand using the elongated interior compartment to teach the child to sell-feed.

27. A method for teaching a child to self-feed, the method comprising:
providing a package to a child comprising a body defining side walls, a first end wall, an inclined second end wall and an elongated interior compartment housing consumable products, the second end wall having a width that is about as wide as an average eating utensil;
providing an eating utensil to the child; and
guiding the eating utensil using the elongate interior compartment to teach the child to self-feed.

28. A method for teaching a child to self-feed, the method comprising:
providing a package to a child comprising a body defining side walls, a bottom wall, a top wall, first end wall oriented at 90° to the bottom wall, a second end wall inclined at an obtuse angle with respect to the bottom wall, and an interior compartment housing consumable products, the interior compartment gradually tapering in width from the second end wall to the first end wall, and the package being so constructed and arranged to stand upright on at least a portion of first end wall; and
using the inclined second end wall to scoop the consumable products for self-feeding.

29. The method of claim 28, wherein the consumable products are scooped using a child's hand.

30. A method of marketing consumable products, the method comprising:
providing a package comprising a body defining side walls, a bottom wall, a top wall, first end wall oriented at 90° to the bottom wall, a second end wall inclined at an obtuse angle with respect to the bottom wall, and an interior compartment housing consumable products, the interior compartment gradually tapering in width from the second end wall to the first end wall, and the package being so constructed and arranged to stand upright on at least a portion of first end wall; and
standing the package on a retail shelf in a substantially upright position such that the package stands on at least a portion of the first end wall.
